(19) United States
(12) Patent Application Publication
(10) Pub. No.: US 2010/0060885 A1
(43) Pub. Date: Mar. 11, 2010

(54) Method and device for performing optical suspension measurement

(76) Inventors: Guenter Nobis, Nuertingen (DE); Steffen Abraham, Hildesheim (DE); Bernd Schmidtke, Leonberg (DE); Christian Knoll, Stuttgart (DE); Ulrich Kallmann, Tuebingen (DE)

Correspondence Address: MICHAEL J. STRIKER, 103 EAST NECK ROAD, HUNTINGTON, NY, 11743, US

(21) Appl. No.: 12/516,447

(22) PCT Filed: Apr. 14, 2008
(86) PCT No.: PCT/EP08/54473

§ 371 Date: May 27, 2009

(30) Foreign Application Priority Data
May 7, 2007 (DE) 10 2007 021 328.1

(51) Int. Cl. G01B 5/00; G01B 11/26

(52) U.S. Cl. 356/139.09; 33/288

(57) ABSTRACT

The invention relates to a method for optically measuring an undercarriage and/or for dynamically testing undercarriage components of a motor vehicle (1). At least one wheel (2) and/or at least one section of the vehicle (1) is illuminated with a light pattern (15) of structured light by means of an illumination device (11), and the reflected light (4′) is received by means of an imaging sensor unit (12, 13) and evaluated in an evaluation unit (16). The invention also relates to a device for carrying out the method. Even in suboptimal light conditions in the surrounding environments, a robust measurement is achieved because the structured light is emitted by the illumination device in a narrow band in a specified narrow emission wavelength range, and because the light is likewise detected by means of the sensor unit (12, 13) in a receiving wavelength range corresponding to the emission wavelength range and is evaluated in the evaluation unit (16), wherein foreign light influences are removed.

### BACKGROUND INFORMATION

The present invention relates to a method for measuring a chassis and/or for dynamically testing chassis components of a motor vehicle, in which at least one wheel and/or at least one section of the vehicle is illuminated via an illumination device using a pattern of structured light, and in which the reflected light is recorded via an imaging sensor unit and is evaluated in an evaluation device. The present invention also relates to a device for carrying out the method.

A method and a device of this type are described in DE 103 35 829 A1 and the parallel publication EP 1 505 367 A2. In this known method for determining axle geometry, a light pattern, such as a pattern of strips having a varying periodicity, monochromatic grid structures, or flat coding in the form of color coding is projected onto the end face of the wheel, and the light that is reflected by the end face of the wheel is received by an image converter from a direction that is different from the projection direction while the wheel rotates in order to determine the normal vector of the wheel and/or a reference plane in the most accurate and robust manner possible, despite the presence of uneven areas which exist on conventional wheels. It is difficult, however, to obtain reliable measurement results with high precision using contactless optical methods of this type for measuring a chassis.

U.S. Pat. No. 4,745,469 also describes a method in which an axle is measured in an optical, contactless manner based on the rotational axis that was determined. The vehicle is situated on a chassis dynamometer while the measurement is carried out, the measurement being used to determine the toe and camber angle. Laser lines or another type of pattern are projected onto the wheel and the tire using a projection system. The patterns are depicted using cameras, and, via triangulation, the 3D coordinates on the surface are reconstructed based on the camera coordinates and the knowledge of the surface, the position of the wheel is determined, which is then used to determine the toe and camber.

DE 10 2005 063 082 A1 and DE 10 2005 063 083 A1 also describe methods for optically measuring a chassis, in which structured light is projected onto the wheel and onto the chassis areas surrounding it, and the structured light is subsequently registered by an imaging sensor system.

According to other methods and devices for determining the rotational axis and measuring the axle geometry, the vehicle is observed using a mono-camera system or a stereo camera system, as shown, e.g. in EP 0 895 056 A2 and DE 29 48 573 A1. Pronounced features, e.g. the rim edge, are localized in the shaded picture of the camera image. Based on the geometric position of the rim edge or other features in the image, their position in three dimensions is determined, and, based thereon, the toe and camber are determined. A measurement method of this type is also described in DE 10 2004 013 441 A1, wherein a 3D model is created to determine the rotational axis of the wheel. In the measurement, e.g. stereo images of the wheel rim are also recorded, and the angular position of the valve is determined. DE 10 2005 017 624 describes how to define wheel features and/or body features by determining a 3D point cloud which is used to determine the wheel and/or axle geometry of motor vehicles, wherein images of the rotating wheel are also recorded, in particular, while the motor vehicle is driven past.

Methods also exist in which, instead of relying on existing wheel features, special markings are applied using mechanical auxiliary means, as shown, e.g. in DE 100 32 356 A1. Although markings of this type for performing the measurement and evaluation serve as easily-detected structures on the wheel, they require additional effort to be realized.

Furthermore, optical measurement methods used to test further chassis components, such as shock absorbers, and to test joint play are described in DE 199 49 704 A1 and DE 199 49 982 C2, in which the motion of the wheel and/or body is measured optically.

In all of these contactless, optically measuring methods and devices, it is difficult without the use of special markings, and with the use of projected light to carry out exact, reliable, robust chassis measurements and/or dynamic tests of chassis components, in particular under raw, real measurement conditions, and with the requirement that the measurement be carried out in the simplest manner possible.

The object of the present invention is to provide a method for measuring a chassis and/or for dynamically testing chassis components of a motor vehicle using structured illumination, which is as robust as possible against external disturbing influences.

### DISCLOSURE OF THE INVENTION

This object is achieved via the features mentioned in claim 1 and claim 11. It is provided that the structured light is emitted by the illumination device in a narrow band in a specified narrow emission wavelength range, and the light is registered by the sensor unit, likewise in a narrow band, and in a receiving wavelength range that corresponds to the emission wavelength range, and it is evaluated in the evaluation device, wherein extraneous-light influences are removed. In the device, the object is attained by the fact that the illumination device is designed to generate narrowband light in a specified wavelength range, and the sensor unit for detecting the light in the narrow wavelength range includes an imaging lens system having at least one spectrally selective, optical element. Given these measures, the structured light pattern may be detected and evaluated in a reliable manner, even in unfavorable ambient light conditions, in particular in the presence of strong ambient light.

Alternative advantageous embodiments result from the fact that the narrowband light is emitted from a light source that generates narrowband light, or it is generated using a projection lens system.

A reliable mode of operation may be attained by using the projection lens system to generate the narrowband light using spectrally selective, optical elements.

Reliable functionality may also be ensured by using a laser and a refractive and/or diffractive projection lens system, or a laser projection system having dynamically moveable mirrors to generate the narrowband light, and by using a light-emitting diode system that emits light in a narrow band, and an adapted projection lens system to generate the narrowband light.

Further advantages may be attained by using the projection lens system to also generate the pattern of the structured light.

According to various further possible embodiments, the light pattern that is generated is a regular or irregular pattern of points, a pattern of lines or strips, a random pattern, or a combination of at least two of these light patterns.

A reliable measurement is also attained by the fact that the reflected light in the imaging sensor unit is directed to a detector unit via an imaging lens system in which the imaging parameters are specified or influenced via a lens system, and the spectral adaptation to the narrowband light emitted by the illumination device is carried out using at least one spectrally selective, optical element.

Advantageous measures exist given that the at least one spectrally selective, optical element is also used to influence the imaging parameters, and/or the spectral adaptation is supported via the beam guidance in the imaging lens system, and/or via the curvature of the spectrally selective, optical element, wherein undesired properties of the spectral selectivity are reduced to a minimum.

The measurement accuracy, in particular in cases in which an imaging lens system having a large angular aperture of the lens is used, is improved by the fact that, in the imaging lens system, the angle of the light that enters at a slant relative to the optical axis is reduced before it enters the at least one spectrally selective, optical element, and by the fact that the at least one spectrally selective, optical element (43) is situated within the imaging lens system at a point at which the angle of light that enters the imaging lens system at a slant relative to the optical axis is reduced. A similar influencing of the angle at which light enters the spectrally selective, optical element may also be brought about solely or in addition thereto via a curvature of the optical element.

An advantageous procedure for carrying out the measurement is to perform the evaluation based on the light pattern, in particular on a pattern of points, of reflected light, based on which a wheel-based, 3D point cloud is determined, and a parametric surface model of the wheel is adapted thereto, and wherein the wheel axis is determined via calculation of wheel normal vectors for various rotational positions of the wheel, and wherein the rotational axis vector is determined as the rotational axis based on the movement of the wheel normal vector in three dimensions.

### EXEMPLARY EMBODIMENTS

The present invention is explained in greater detail below using exemplary embodiments, with reference to the drawings.

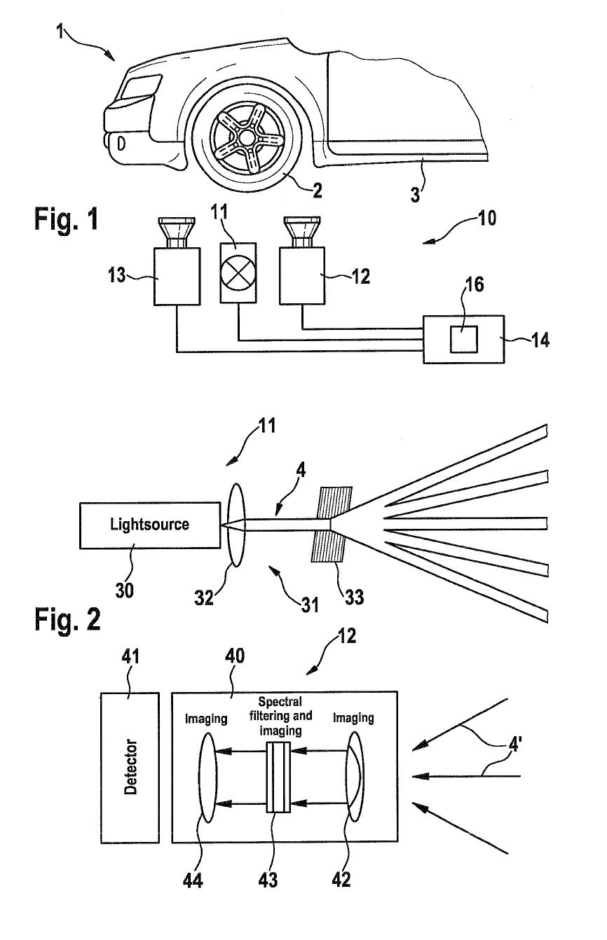

FIG. 1 shows a schematic view of a measuring device in a measurement environment for measuring a chassis,

FIG. 2 is a schematic depiction of an illuminating device and a sensor unit, and

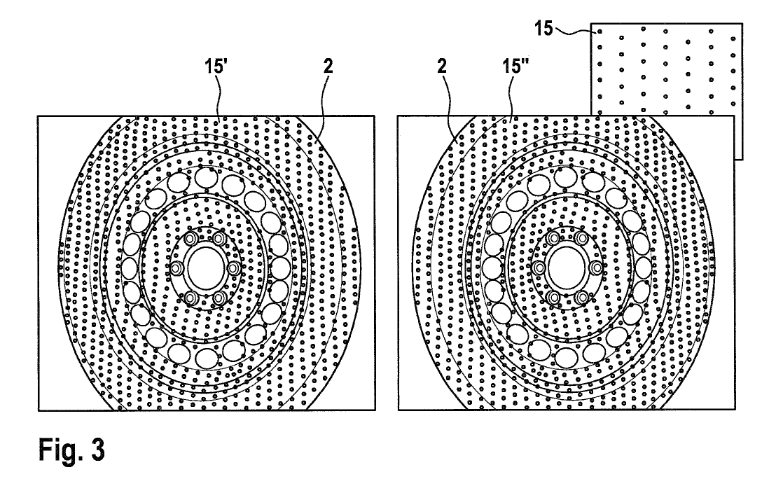

FIG. 3 shows a projected light pattern from the perspective of a left-hand image recording unit and a right-hand image recording unit of the sensor unit.

FIG. 1 shows a measurement environment for measuring a chassis, e.g. for determining the rotational axis of a vehicle wheel 2 according to a method that is described in greater detail in DE 10 2006 048 725.7, and a test set-up using a measuring device 10, wherein the vehicle may move past measuring device 10. In addition to wheel 2, body 3, preferably in the vicinity of wheel 2, may also be incorporated in the measurement.

Measuring device 10 includes a projection device 11 for light pattern 15, e.g. a pattern of points of light (see FIG. 3), and two imaging sensor units 12, 13 which are situated in a specified spatial position and direction relative to projection device 11, and a control unit 14 which is connected to projection device 11 and imaging sensor units 12, 13 which are positioned in a stereo configuration, for the purpose of transmitting data; measuring device 10 also includes electronic devices for controlling projection device 11, imaging sensor units 12, 13, and any optional components that may also be connected, and electrical devices for evaluating the data and depicting the measured results, such as an evaluation device 16.

FIG. 2 shows projection device 11 and imaging sensor unit 12 in greater detail. A light source 30 emits light 4 via an illumination lens system 31 which includes at least one refractive beam-shaping unit 32 and/or one or more diffracting beam-shaping units 33. As an alternative to the design that is shown, a second refractive unit, e.g. a microlens array, may be used, e.g. in place of diffracting beam-shaping unit 33. Emitted light 4 is structured, and it has light pattern 15 that was described above. In addition, emitted light 4 that exits illumination lens system 31 is narrowband and covers only a narrow wavelength range of, e.g. one or more nanometers, e.g. 30 nm (measured at 50% of the maximum radiation output). It is advantageous to use a wavelength range that is within the visible spectral range, e.g. the red spectral range, for purposes of visual inspection.

FIG. 2 also shows that light 4′ reflected by wheel 2 and/or body 3 is registered using a receiver lens system designed as an imaging lens system 40, and it is directed to a detector unit 41 in order to evaluate the signals that were received. Imaging lens system 40 includes a lens system having imaging optical elements 42, 44 and at least one spectrally selective, optical element in the form of a spectral filter unit 43, the spectral pass band of which is adapted to the bandwidth of emitted light 4 and reflected light 4′, thereby ensuring that, in particular, this light to be utilized is allowed to pass to detection unit 41, and the influence of extraneous light from the surroundings is suppressed. The filter transmission band of spectral filter unit 43 is also small, e.g. a few nanometers larger than the bandwidth of reflected light 4′ to be used, and it is, e.g. up to 30 nm, or a maximum of 50 nm (at 50% of maximum output), wherein the mean wavelength of the useful light and the spectral filter are approximately the same.

Light 4 emitted by the illumination device via projection unit 11 contains the light pattern, wherein the structure of the light pattern may be a regular or irregular pattern of points, a line or stripe pattern, a random pattern, or a combination of these structures. Possible technical variants for the illumination or projection of the light pattern are illumination using a laser and special projection lens systems, in particular refractive and/or diffractive lens systems, laser projection systems having dynamically movable mirrors, light-emitting diodes (LEDs) that emit light in a narrow band and having specially adapted projection lens systems, or spectrally narrowed light sources that emit light in a broad band, e.g. thermal radiators, having special projection lens systems. In addition to light source 30, the illumination device includes refractive and/or diffractive optical elements or a projection system having dynamically movable mirrors for generating a projected illumination structure. The emitted light may be clock-pulse controlled, e.g. with a period in the range of 1 ms to 10 ms.

The lens system of the receiving lens system or imaging lens system 40 is designed to attain or adjust optimal imaging parameters. The spectrally selective, optical elements, e.g. colored glass or interference filters, are spectrally adapted to the spectrum of emitted light 4 or reflected light 4′, wherein the spectrally selective elements may be used simultaneously for the imaging and filter function by presenting them in a suitable manner, e.g., via curvature and/or their position in the imaging ray path. The properties of the spectrally selective elements may be supported by guiding the ray in imaging lens system 40 in a suitable manner. A suitable ray guidance in imaging lens system 40 may also be used to suppress or reduce to a minimum any undesired properties of the spectrally selective elements, such as directionality of the filter effect. These measures advantageously make it possible, by using a lens having a large aperture angle, to filter light that enters imaging lens system 40 at a slant relative to the optical axis with a spectrally narrow band, thereby advantageously making it possible to realize large lens aperture angles of, e.g. greater than 40° or 50°, in the measuring device, wherein the filter characteristic remains approximately constant depending on the angle of incidence.

Imaging sensor units 12, 13 are, e.g. cameras, wherein imaging lens system 40 is designed as a camera lens system.

The spectral narrowband-nature of the light that forms light pattern 15, and the receiving lens system make it possible to perform a reliable measurement even in the presence of strong ambient light, e.g. bright sunlight, since reflected light 4′ having the light pattern may be reliably distinguished from the ambient light. Based on this, a reliable, unambiguous evaluation of light pattern 15′, 15″ reflected by the wheel is obtained.

FIG. 3 shows light pattern 15, and light patterns 15′ and 15″ which are reflected by the wheel, and which result from the perspective of imaging sensor units 12, 13 in the form of a left-hand and right-hand stereo camera, wherein the alignment of light points on lines is curved differently in the two images. The light pattern is, e.g. a pattern of laser-light points.

Based on the stereo displacement vector for various angles of inclination along lines of inclination relative to imaging sensor units 12, 13, it is possible to determine, e.g. wheel-based 3D point clouds, as explained in greater detail in DE 10 2006 048 725.7 mentioned above.

Measuring device 10 is designed to carry out an exact, robust measurement of a chassis and/or to perform dynamic testing of chassis components. Via the projection of light pattern 15, the method is independent of reference points that are fixedly linked to the wheel surface or wheel texture, and/or, possibly, to the chassis surface, and they move with them when they move. It is therefore not necessary to recognize structures on the surface of the wheel or chassis. Instead, the structured illumination using light pattern 15 creates stable features that are not permanent features of the surface of the wheel or chassis, and therefore do not move with them when they move. For example, in the method presented here, the position of the rotational axis of wheel 2 may be determined with greater robustness even when the motor vehicle drives past measuring device 10. It is no longer necessary for the wheel to rotate in a fixed position (on a chassis dynamometer or by raising the vehicle). When the position of the rotational axes is known, e.g. it is possible to determine the axle geometry, such as the toe and camber. It is also possible to compensate for rim runout.

The 3D measurement which is based on the structured illumination using light pattern 15 may be carried out using sensor units 12, 13 which are provided in the stereo configuration, and using a mono-camera system or multiple-camera system, wherein an algorithmic evaluation of the measured data is carried out by determining a 3D point cloud, as is the case with the stereo configuration.

When the method is carried out, as the vehicle drives past and wheel 2 rotates, the pattern is projected and, based thereon, a calculation of a 3D point cloud is carried out once in every time interval. In the 3D point cloud, e.g. a parametric surface model of wheel 2 or the body is created for the evaluation, as described in greater detail in R.315415 mentioned above. A tiny-meshed pattern of laser light points as shown in FIG. 3 is projected onto the tires as the light pattern. For every point of laser light, the depth is calculated based on the displacement vectors (disparity) of the stereo images of the camera system in order to increase accuracy and robustness, wherein the narrowband illumination light and the light that is received via the narrowband receiver system result in more reliable detection and increased measurement accuracy.

What is claimed is:

1. A method for measuring a chassis and/or for dynamically testing chassis components of a motor vehicle (1), in which at least one wheel (2) and/or at least one section of the vehicle (1) is illuminated via an illumination device (11) using a light pattern (15) of structured light; the reflected light (4′) is registered via an imaging sensor unit (12, 13) and evaluated in an evaluation device (16),
wherein
the structured light is emitted by the illumination device in a narrow band in a specified narrow emission wavelength range, and the light is registered via the sensor unit (12, 13), likewise in a narrow band, in a receiving wavelength range that corresponds to the emission wavelength range, and it is evaluated in the evaluation device (16), wherein extraneous-light influences are removed.

2. The method as recited in claim 1,
wherein
the narrowband light is emitted from a light source that generates narrowband light, or it is generated using a projection lens system.

3. The method as recited in claim 2,
wherein
the narrowband light is generated by the projection lens system using spectrally selective, optical elements.

4. The method as recited in claim 2,
wherein
the narrowband light is generated using a laser and a refractive and/or diffractive projection lens system, or a laser projection system that includes dynamically movable mirrors.

5. The method as recited in claim 2,
wherein
the narrowband light is generated by a light-emitting diode system that emits light in a narrow band, and by an adapted projection lens system.

6. The method as recited in claim 2,
wherein
the light pattern of the structured light is also generated using the projection lens system.

7. The method as recited in claim 1,
wherein
the light pattern that is generated is a regular or irregular pattern of points, a pattern of lines or strips, a random pattern, or a combination of at least two of these light patterns.

8. The method as recited in claim 1,
wherein
the reflected light (4′) in the imaging sensor unit (12, 13) is directed to a detector unit (41) via an imaging lens system (40) in which the imaging parameters are specified or influenced via a lens system, and the spectral adaptation to the narrowband light emitted by the illumination device (11) is carried out using at least one spectrally selective, optical element.

9. The method as recited in claim 8,
wherein
the at least one spectrally selective, optical element (43) is also used to influence the imaging parameters, and/or the spectral adaptation is supported via the beam guidance in the imaging lens system (40), and/or via the curvature of the spectrally selective, optical element, wherein undesired properties of the spectral selectivity are reduced to a minimum.

10. The method as recited in claim 8,
wherein,
in the imaging lens system (40), the angle of light that enters a slant relative to the optical axis is reduced before it enters the at least one spectrally selective, optical element (43).

11. The method as recited in claim 1,
wherein,
in performing the evaluation based on the light pattern (15), in particular on a pattern of points, of reflected light (4′), a wheel-based, 3D point cloud (20) is determined, and a parametric surface model of the wheel (2) is adapted thereto, and wherein the wheel axis is determined via calculation of wheel normal vectors for various rotational positions of the wheel (2), and wherein, the rotational axis vector is determined as the rotational axis based on the movement of the wheel normal vector in three dimensions.

12. A device for carrying out the method as recited in claim 1, which includes an illumination device (11) for generating a structured light pattern (15) and illuminating at least one wheel (2) and/or at least one section of the vehicle (1) with the light pattern (15), an imaging sensor unit (12, 13) for registering the reflected light (4′), and an evaluation device (16),
wherein
the illumination device (11) is designed to generate narrowband light in a specified wavelength range, and the sensor unit (12, 13) includes an imaging lens system (40) having at least one spectrally selective, optical element (43) for detecting the light in the narrowband wavelength range.

13. The device recited in claim 12,
wherein
the at least one spectrally selective, optical element (43) is situated inside the imaging lens system (40) at a point at which the angle of light that enters the imaging lens system (40) at a slant relative to the optical axis is reduced, and/or wherein the at least one spectrally selective, optical element is curved in order to prevent the directionality of the spectral filter characteristic.
